(19) United States
(12) Patent Application Publication
(10) Pub. No.: US 2010/0183874 A1
(43) Pub. Date: Jul. 22, 2010

(54) PRIMER HAVING A HOT-MELT ADHESIVE COMPOSITION

(75) Inventors: Wolf-Ruediger Huck, Zurich (CH); Andreas Braun, Wolfhalden (CH)

Correspondence Address: BUCHANAN, INGERSOLL & ROONEY PC, POST OFFICE BOX 1404, ALEXANDRIA, VA, 22313-1404, US

(73) Assignee: SIKA TECHNOLOGY AG, Baar (CH)

(21) Appl. No.: 12/651,106

(22) Filed: Dec. 31, 2009

Related U.S. Application Data
(63) Continuation of application No. PCT/EP2008/061396, filed on Aug. 29, 2008.

(30) Foreign Application Priority Data
Aug. 31, 2007 (EP) 07115438.9

(51) Int. Cl. C09J 175/04; B32B 37/12; B05D 5/10; B32B 27/40

(52) U.S. Cl. 428/354; 525/458; 156/329; 427/207.1; 428/355 N; 428/423.1

(57) ABSTRACT

Primers are disclosed that include hot-melt adhesive compositions that contain at least one polyurethane polymer that has isocyanate groups and/or silane groups for adhesives or sealing materials or for compositions for the production of coatings. Such primers are suitable for moisture-hardening polyurethane compositions and are VOC-free or are at least low-VOC.

### RELATED APPLICATIONS

This application claims priority as a continuation application under 35 U.S.C. §120 to PCT/EP2008/061396, which was filed as an International Application on Aug. 29, 2008 designating the U.S., and which claims priority to European Application 07115438.9 filed in Europe on Aug. 31, 2007. The entire contents of these applications are hereby incorporated by reference in their entireties.

### FIELD

The disclosure relates to the field of primers, such as primers free of volatile organic compounds.

### BACKGROUND INFORMATION

Primers have been used as undercoats to improve the adhesion of adhesives, sealing materials and coatings on subsurfaces. In addition to a binder, primers can, for example, contain silanes, titanates, and/or zirconates as adhesion promoters.

For thin-layer application, primers can have large amounts (e.g., in a range of >70% by weight) of solvents, such as volatile organic compounds, so-called VOCs (Volatile Organic Compounds). Both for ecological reasons and for reasons of safety and health, it can be desirable to use VOC-free or at least low-VOC primers.

VOC-containing primers can raise concerns with respect to ecology, health and safety, and their desired application can involve an air-out time. The air-out time can, for example, depend on the solvent that is used and on the ambient temperature in the application and can be, for example, from about 10 minutes up to more than 24 hours.

### SUMMARY

A primer formed as a hot-melt adhesive composition is disclosed comprising: at least one polyurethane polymer having at least one of isocyanate groups and silane groups; and at least one of an adhesive, a sealing material and a composition for production of coating.

A process for bonding is disclosed, comprising:
a1) applying a molten hot-melt adhesive composition containing at least one polyurethane polymer that has at least one of an isocyanate group and a silane group on a substrate that is to be bonded; and
a2) applying a second adhesive on the hot-melt adhesive composition that is cooled below its melting point and that is on the substrate ensuring contact between the second adhesive and a second substrate; or
b1) applying a molten hot-melt adhesive composition that contains at least one polyurethane polymer that has at least one of an isocyanate group and a silane group on a first substrate that is to be bonded; and
b2) applying a second adhesive on a surface of a second substrate ensuring contact between the second adhesive and the hot-melt adhesive composition that is cooled below its melting point and that is on the first substrate, within an open time of the second adhesive; or
c1) applying a molten hot-melt adhesive composition that contains at least one polyurethane polymer that has at least one of an isocyanate group and a silane group on a first substrate that is to be bonded;
c2) applying a molten hot-melt adhesive composition that contains at least one polyurethane polymer that has at least one of an isocyanate group and a silane group on a second substrate that is to be bonded;
c3) applying a second adhesive on the hot-melt adhesive composition that is cooled below its melting point and that is on at least one of the first substrate and the second substrate; and
c4) fusing the first substrate, that is coated with the hot-melt adhesive composition, with the second substrate that is coated with the hot-melt adhesive composition, within an open time of the second adhesive; or
d1) applying a molten hot-melt adhesive composition that contains at least one polyurethane polymer that has at least one of an isocyanate group and a silane group on at least one of a first substrate and a second substrate that is to be bonded;
d2) cooling the hot-melt adhesive composition below its melting point; and
d3) applying a second adhesive between surfaces of the first and second substrates.

A process for a substrate is disclosed, comprising:
applying a molten hot-melt adhesive composition that contains at least one polyurethane polymer that has at least one of an isocyanate group and a silane group on at least one of a first substrate and a second substrate; and
applying a composition on the hot-melt adhesive composition that is cooled below its melting point and that is on at least one of the first substrate and the second substrate.

A layer composite is disclosed, comprising: a least a first substrate of a hot-melt adhesive composition that contains at least one polyurethane polymer that has at least one of an isocyanate group and a silane group; and a second composition, which is a second adhesive, a sealing material, or a composition for the production of coatings, wherein a layer of the hot-melt adhesive composition adjoins at least one layer of the second composition.

An article produced according to a process for bonding is disclosed which comprises:
a1) applying a molten hot-melt adhesive composition containing at least one polyurethane polymer that has at least one of an isocyanate group and a silane group on a substrate that is to be bonded; and
a2) applying a second adhesive on the hot-melt adhesive composition that is cooled below its melting point and that is on the substrate ensuring contact between the second adhesive and a second substrate; or
b1) applying a molten hot-melt adhesive composition that contains at least one polyurethane polymer that has at least one of an isocyanate group and a silane group on a first substrate that is to be bonded; and
b2) applying a second adhesive on a surface of a second substrate ensuring contact between the second adhesive and the hot-melt adhesive composition that is cooled below its melting point and that is on the first substrate, within an open time of the second adhesive; or
c1) applying a molten hot-melt adhesive composition that contains at least one polyurethane polymer that has at least one of an isocyanate group and a silane group on a first substrate that is to be bonded;
c2) applying a molten hot-melt adhesive composition that contains at least one polyurethane polymer that has at least one of an isocyanate group and a silane group on a second substrate that is to be bonded;
c3) applying a second adhesive on the hot-melt adhesive composition that is cooled below its melting point and that is on at least one of the first substrate and the second substrate; and
c4) fusing the first substrate, that is coated with the hot-melt adhesive composition, with the second substrate that is coated with the hot-melt adhesive composition, within an open time of the second adhesive; or
d1) applying a molten hot-melt adhesive composition that contains at least one polyurethane polymer that has at least one of an isocyanate group and a silane group on at least one of a first substrate and a second substrate that is to be bonded;
d2) cooling the hot-melt adhesive composition below its melting point; and
d3) applying a second adhesive between surfaces of the first and second substrates.

### BRIEF DESCRIPTION OF THE DRAWINGS

Other objects and advantages of exemplary embodiments will become apparent from the following detailed description of preferred embodiments, when read in conjunction with the accompanying drawings, wherein like elements are represented by like numerals, and wherein:

FIG. 1 shows an exemplary layer composite with a substrate and hot-melt adhesive composition;

FIG. 2 shows another exemplary layer composite with multiple layers of hot-melt adhesive composition; and

FIG. 3 shows an exemplary layer composite having a layer of a hot-melt adhesive composition with a coating.

### DETAILED DESCRIPTION

A primer is disclosed for adhesives or sealing materials or for compositions for the production of coatings that is, for example, VOC-free or is at least low-VOC.

It has been found, surprisingly, that hot-melt adhesive compositions, containing at least one polyurethane polymer that has isocyanate groups and/or that has silane groups, can yield very good adhesion results as VOC-free or at least low-VOC primers for adhesives or sealing materials or for compositions for the production of coatings.

Hot-melt adhesive compositions are, for the most part, free of volatile organic compounds, and thus their use as primers from ecological, health and safety standpoints, but also relative to adhesion results, can be desirable over known primer.

Primers formed with hot-melt adhesive compositions can be formed without any volatile organic solvents; also, air-out time can be avoided and/or redirected in the applied primer. This can facilitate application of such primers where the adhesive, sealing material or the coating is to be applied directly after the application of the primer. Under these circumstances, the hot-melt adhesive composition primer can be cooled below its application temperature even before the chemical cross-linking, such that a physical stiffening can occur, which can impart a certain initial strength to the adhesive composite.

In a first aspect, an exemplary hot-melt adhesive composition is disclosed which includes at least one polyurethane polymer that has isocyanate groups and/or that has silane groups, as a primer for adhesives or sealing materials or as a primer for compositions for the production of coatings.

In this document, substance names beginning with “poly,” such as polyol or polyisocyanate, refer to substances that formally contain per molecule two or more of the functional groups that occur in their names.

In this document, the term “polymer” comprises, on the one hand, a collective of chemically uniform macromolecules that are different, however, relative to the degree of polymerization, molecular weight, and chain length, and said collective was produced by a polyreaction (polymerization, polyaddition, polycondensation). The term also comprises, on the other hand, derivatives of such a collective of macromolecules from polyreactions, compounds that were obtained by reactions such as, for example, additions or substitutions of functional groups at specified macromolecules, and that can be chemically uniform or chemically non-uniform. In addition, the term also comprises so-called prepolymers, i.e., reactive oligomer prepolymers, whose functional groups are involved in the build-up of macromolecules.

The term “polyurethane polymer” comprises all polymers that are produced according to the so-called diisocyanate-polyaddition process. This also includes those polymers that are almost or entirely free of urethane groups. Examples of polyurethane polymers are polyether polyurethanes, polyester polyurethanes, polyether polyureas, polyureas, polyester polyureas, polyisocyanurates and polycarbodiimides.

In this document, the term “organosilane” refers to silanes, which have at least one alkoxy group or an acyloxy group as well as at least one organic radical, which is bonded to the silicon atom via an Si—C bond and optionally has functional groups with heteroatoms such as amino or mercapto groups. Organosilanes, whose organic radical has an amino group or a mercapto group, are referred to as “aminosilanes” or “mercaptosilanes.” According to this definition, “tetraalkoxysilanes” do not represent any organosilanes.

In this document, “volatile organic compounds,” also called VOC (“Volatile Organic Compounds”), are defined as organic compounds that have a boiling point of less than 250° C. at normal pressure or a vapor pressure of greater than 0.1 mbar at 20° C.

A temperature of, for example, 23° C. (more or less) is referred to as “room temperature.”

An exemplary hot-melt adhesive composition includes at least one polyurethane polymer that has isocyanate groups and/or silane groups that are solid at room temperature. In particular, the hot-melt adhesive composition includes at least one polyurethane polymer that has isocyanate groups, such as an isocyanate-group-terminated polyurethane polymer.

A suitable polyurethane polymer P that has isocyanate groups can be obtained by the reaction of at least one polyol with at least one polyisocyanate.

Polyether polyols, polyester polyols and polycarbonate polyols as well as mixtures of these polyols are suitable as polyols.

Polyether polyols, also called polyoxyalkylene polyols, can include those that are the polymerization product of ethylene oxide, 1,2-propylene oxide, 1,2- or 2,3-butylene oxide, tetrahydrofuran or mixtures thereof, optionally polymerized using a starter molecule with two or more active H atoms, such as, for example, water, ammonia or compounds with two or more OH or NH groups, such as, for example, 1,2-ethanediol, 1,2- and 1,3-propanediol, neopentyl glycol, diethylene glycol, triethylene glycol, the isomeric dipropylene glycols and tripropylene glycols, the isomeric butanediols, pentanediols, hexanediols, heptanediols, octanediols, nonanediols, decanediols, undecanediols, 1,3- and 1,4-cyclohexanedimethanol, bisphenol A, hydrated bisphenol A, 1,1,1-trimethylolethane, 1,1,1-trimethylolpropane, glycerol, aniline as well as mixtures of the above-mentioned compounds. The polyoxyalkylene diols can have different degrees of unsaturation (measured according to ASTM D-2849-69 and indicated in milliequivalents of unsaturation per gram of polyol (mEq/g)). Those with a low degree of unsaturation are produced, for example, using so-called double-metal cyanide complex catalysts (DMC catalysts); those with a higher degree of unsaturation are produced, for example, using anionic catalysts, such as NaOH, KOH, CsOH or alkali alcoholates.

Polyoxyalkylene diols or polyoxyalkylene triols with a degree of unsaturation of ≦mEq/g and with a molecular weight in the range of 1,000 to 30,000 g/mol, as well as polyoxyethylene diols, polyoxyethylene triols, polyoxypropylene diols and polyoxypropylene triols with a molecular weight of 400 to 8,000 g/mol, are especially suitable. Polyoxypropylene diols with a degree of unsaturation of ≦0.02 mEq/g and a molecular weight in the range of 1,000 to 12,000 g/mol, preferably 1,000 to 8,000 g/mol, are especially suitable. Such polyether polyols are commercially available, for example, under the trade name Acclaim® of the company Bayer MaterialScience AG, Germany. In this document, “molecular weight” is defined as the molecular weight means Mn.

So-called ethylene-oxide-terminated (“EO-endcapped,” ethylene oxide-endcapped) polyoxypropylene polyols are also especially suitable. The latter are special polyoxypropylene polyoxyethylene polyols, which are obtained, for example, in that pure polyoxypropylene polyols, such as polyoxypropylene diols and triols, are further alkoxylated with ethylene oxide after the polypropoxylation reaction has been completed and thus have primary hydroxyl groups.

Also suitable are hydroxyl-group-terminated polybutadiene polyols, such as, for example, those that are produced by polymerization of 1,3-butadiene and allyl alcohol or by oxidation of polybutadiene, as well as their hydrogenation products.

Also suitable are styrene-acrylonitrile-plugged polyether polyols, as are commercially available from, for example, the company Elastogran GmbH, Germany, for example under the trade name Lupranol®.

As polyester polyols, polyesters that carry at least two hydroxyl groups are especially suitable and are produced according to known processes, such as the polycondensation of hydroxycarboxylic acids or the polycondensation of aliphatic and/or aromatic polycarboxylic acids with divalent or multivalent alcohols.

Polyester polyols, which are produced from divalent to trivalent alcohols, such as, for example, 1,2-ethanediol, diethylene glycol, 1,2-propanediol, dipropylene glycol, 1,4-butanediol, 1,5-pentanediol, 1,6-hexanediol, neopentyl glycol, glycerol, 1,1,1-trimethylolpropane or mixtures of the above-mentioned alcohols with organic dicarboxylic acids or their anhydrides or esters, such as, for example, succinic acid, glutaric acid, adipic acid, trimethyl adipic acid, suberic acid, azelaic acid, sebacic acid, dodecanedicarboxylic acid, maleic acid, fumaric acid, dimeric fatty acid, phthalic acid, phthalic acid anhydride, isophthalic acid, terephthalic acid, dimethyl terephthalate, hexahydrophthalic acid, trimellitic acid, and trimellitic acid anhydride or mixtures of the above-mentioned acids, as well as polyester polyols from lactones, such as, for example, ε-caprolactone, are especially suitable.

Polyester diols are especially suitable: in particular those that are produced from adipic acid, azelaic acid, sebacic acid, dodecanedicarboxylic acid, dimeric fatty acid, phthalic acid, isophthalic acid and terephthalic acid as dicarboxylic acid or from lactones, such as, for example, ε-caprolactone and from ethylene glycol, diethylene glycol, neopentyl glycol, 1,4-butanediol, 1,6-hexanediol, dimeric fatty acid diol and 1,4-cyclohexanedimethanol as a divalent alcohol.

The polyester polyols can have a molecular weight of 1,000 to 15,000 g/mol, such as 1,500 to 8,000 g/mol, and preferably 1,700 to 5,500 g/mol.

At room temperature, liquid, amorphous, partially crystalline and crystalline polyester diols and triols, such as polyester diols, are especially suitable. Suitable polyester polyols that are liquid at room temperature are solid not far below room temperature, for example at temperatures of between 0° C. and 25° C., and are for example used in combination with at least one amorphous, partially crystalline or crystalline polyester polyol. Amorphous polyester diols as well as mixtures of amorphous polyester diols and polyester diols that are liquid at room temperature are especially suitable.

As polycarbonate polyols, especially those are suitable as are available by reaction, for example, of the above-mentioned alcohols, used for the build-up of polyester polyols, with dialkyl carbonates such as dimethyl carbonate, diaryl carbonates, such as diphenyl carbonate, or phosgene. Polycarbonate diols, especially amorphous polycarbonate diols, are especially suitable.

As polyols, polyester polyols and polycarbonate polyols, such as polyester diols and polycarbonate diols, are preferred. Amorphous polyester diols and amorphous polycarbonate diols, as well as mixtures of amorphous—and, at room temperature, liquid—polyester or polycarbonate diols, are especially preferred. Most preferred are polyester diols, in particular amorphous polyester diols, as well as mixtures that consist of amorphous polyester diols and polyester diols that are liquid at room temperature.

As polyisocyanates for the production of a polyurethane polymer P, commercially available, aliphatic, cycloaliphatic or aromatic polyisocyanates, in particular diisocyanates, can be used.

Suitable diisocyanates are, for example, 1,6-hexamethylene diisocyanate (HDI), 2-methylpentamethylene-1,5-diisocyanate, 2,2,4- and 2,4,4-trimethyl-1,6-hexamethylene diisocyanate (TMDI), 1,10-decamethylene diisocyanate, 1,12-dodecamethylene diisocyanate, lysine and lysine ester diisocyanate, cyclohexane-1,3- and cyclohexane-1,4-diisocyanate, and any mixtures of these isomers, 1-methyl-2,4- and 1-methyl-2,6-diisocyanatocyclohexane and any mixtures of these isomers (HTDI or H₆TDI), 1-isocyanato-3,3,5-trimethyl-5-isocyanatomethyl-cyclohexane (=isophorone diisocyanate or IPDI), perhydro-2,4′- and perhydro-4,4′-diphenylmethane diisocyanate (HMDI or H₁₂MDI), 1,4-diisocyanato-2,2,6-trimethylcyclohexane (TMCDI), 1,3- and 1,4-bis-(isocyanatomethyl)-cyclohexane, m- and p-xylylene diisocyanate (m- and p-XDI), m- and p-tetramethyl-1,3- and p-tetramethyl-1,4-xylylene diisocyanate (m- and p-TMXDI), bis-(1-isocyanato-1-methylethyl)-naphthalene, 2,4- and 2,6-toluylene diisocyanate and any mixtures of these isomers (TDI), 4,4′-, 2,4′- and 2,2′-diphenylmethane diisocyanate and any mixtures of these isomers (MDI) as well as polymeric diphenylmethane diisocyanate (PMDI), 1,3- and 1,4-phenylene diisocyanate, 2,3,5,6-tetramethyl-1,4-diisocyanatobenzene, naphthalene-1,5-diisocyanate (NDI), 3,3′-dimethyl-4,4′-diisocyanatodiphenyl (TODI), dianisidine diisocyanate (DADI), oligomers and polymers of the above-mentioned isocyanates as well as any mixtures of the above-mentioned isocyanates. MDI, TDI, HDI and IPDI are, for example, preferred. MDI and IPDI are especially preferred.

The production of the polyurethane polymer P can be carried out in a known way directly from the polyisocyanates and the polyols or by the adduction process in steps, as they are also known as chain-lengthening reactions.

In an exemplary embodiment, the polyurethane polymer P is produced via a reaction of at least one polyisocyanate and at least one polyol, whereby the isocyanate groups are present in a stoichiometric excess compared to the hydroxyl groups. The ratio between isocyanate and hydroxyl groups is, for example, 1.3 to 2.5, especially 1.5 to 2.2, so that a polyurethane polymer P that has isocyanate groups is produced.

A suitable polyurethane polymer that has silane groups can be obtained, for example, from the reaction of a polyurethane polymer P that has isocyanate groups, as described above, with an organosilane that has hydroxyl groups, amino groups, or mercapto groups.

Another process for the production of a suitable silane-group-terminated polyurethane polymer is, for example, the reaction of a hydroxyl- or amino-group-terminated polyurethane polymer with an organosilane that has isocyanate groups.

A suitable polyurethane polymer, which comprises both isocyanate groups and silane groups, can be obtained, for example, from the reaction of a polyurethane polymer P that has isocyanate groups, as described above, with an organosilane that has hydroxyl groups, amino groups, or mercapto groups, whereby the latter is used so that its hydroxyl groups, amino groups or mercapto groups are present in hypostoichiometric form compared to the isocyanate groups of the polyurethane polymer P.

The polyurethane polymer can be solid at room temperature. In this case, it can be crystalline, partially crystalline, or amorphous. For a partially crystalline or amorphous polyurethane polymer, it holds true in this case that it has little or no flowability at room temperature (e.g., it has a viscosity of more than 5,000 Pa·s at 20° C.).

The polyurethane polymer has a molecular weight of, for example, above 1,000 g/mol, such as one between 1,200 and 50,000 g/mol, and preferably one between 2,000 and 30,000 g/mol.

In addition, the polyurethane polymer can have a mean NCO or silane functionality in the range of 1.8 to 2.2.

The polyurethane polymer can be present in an amount of 40 to 100% by weight, such as 75 to 100% by weight, and preferably 80 to 100% by weight, relative to the total weight of the hot-melt adhesive composition.

The hot-melt adhesive composition according to the disclosure can, for example, have less than 5% by weight, such as 0 to 2% by weight, preferably 0 to 1% by weight, and most preferably 0% by weight, in each case relative to the total weight of the hot-melt adhesive composition, of volatile organic compounds.

The previously-described hot-melt adhesive composition optionally can contain additional components, such as those known for use in hot-melt adhesive compositions. In this case, those skilled in the art will appreciate that such additional components can be selected based on the respective composition and their type and amount so that, for example, the shelf life of the composition is not impaired.

The previously-described hot-melt adhesive composition can optionally contain non-reactive thermoplastic polymers, such as, for example, homopolymers or copolymers of unsaturated monomers, in particular from the group that comprises ethylene, propylene, butylene, isobutylene, isoprene, vinyl acetate or higher esters thereof, and (meth)acrylate. Ethylene vinyl acetate copolymers (EVA), atactic poly-α-olefins (APAO), polypropylene (PP) and polyethylene (PE) are especially suitable.

The hot-melt adhesive composition that is described optionally contains catalysts for the reaction of isocyanate groups, such as metal compounds or tertiary amines.

Suitable metal compounds are, for example, tin compounds, such as dibutyl tin diacetate, dibutyl tin dilaurate, dibutyl tin distearate, dibutyl tin diacetylacetonate, dioctyl tin dilaurate, dibutyl tin dichloride, dibutyl tin oxide, and tin(II) carboxylate; stannoxanes such as lauryl stannoxane; or bismuth compounds, such as bismuth(III)-octoate, bismuth(III)-neodecanoate, or bismuth(III)-oxinates.

Suitable tertiary amines are, for example, 2,2′-dimorpholinodiethyl ether and other morpholine ether derivatives, 1,4-diazabicyclo[2,2,2]octane and 1,8-diazabicyclo[5,4,0]undec-7-ene.

Also, the hot-melt adhesive composition can contain mixtures of the above-mentioned catalysts. In this case, mixtures of metal compounds and tertiary amines are especially suitable.

The previously-described hot-melt adhesive composition optionally contains reactive diluters or cross-linking agents, for example oligomers or polymers of diisocyanates, such as MDI, PMDI, TDI, HDI, 1,12-dodecamethylene diisocyanate, cyclohexane-1,3- or cyclohexane-1,4-diisocyanate, IPDI, perhydro-2,4′- and perhydro-4,4′-diphenylmethanediisocyanate, 1,3- and 1,4-tetramethylxylylene diisocyanate, in particular isocyanurates, carbodiimides, uretonimines, biurets, allophanates, and iminooxadiazinediones of the above-mentioned diisocyanates, adducts of polyisocyanates with short-chain polyols, as well as adipic acid dihydrazide and other dihydrazides.

In addition, the previously-described hot-melt adhesive composition can contain other additives. These are in particular fillers, softeners, adhesion promoters, such as silane-group-containing compounds, such as, for example, epoxy silanes, vinyl silanes, (meth)acrylosilanes, isocyanatosilanes, carbamatosilanes and S-(alkylcarbonyl)-mercaptosilanes, as well as oligomeric forms of these silanes, UV absorption agents, UV or heat stabilizers, antioxidants, fireproofing agents, optical brighteners, pigments, dyes and drying agents, as well as other substances that are known in compositions that have isocyanate groups.

The previously-described hot-melt adhesive composition can, for example, be produced and stored with the exclusion of moisture. In a suitable airtight package or arrangement, such as, for example, in a jar, a bag or in a carton, it can have excellent shelf life. In this document, with the terms “storage-stable” and “shelf life” in connection with a compound, the fact is referred to that the viscosity of the composition at the application temperature with suitable storage in the time span that is considered does not increase or at most increases only to the extent that the composition remains usable in the way for which it is designed.

The hot-melt adhesive composition, as it is described above, is suitable as a primer, such as a primer for adhesives or sealing materials or as a primer for compositions for the production of coatings, such as on substrates that are selected from the group that consists of concrete, cement, mortar, brick, adobe, gypsum, natural stone, asphalt, metal, metal alloy, wood, ceramic, glass, plastic, powder coating, paint, and varnish.

In addition, the hot-melt adhesive composition is suitable, as it is described above, as a primer for adhesives or sealing materials or as a primer for compositions for the production of coatings, whereby these adhesives, sealing materials or compositions for the production of coatings are, for example, moisture-hardening polyurethane compositions, a one-component polyurethane compositions. These polyurethane compositions can, for example, harden at room temperature by means of moisture, such as air humidity.

The hot-melt adhesive composition, as it is described above, is suitable as a primer for moisture-hardening polyurethane compositions, which comprise at least one polyurethane polymer that has silane groups and/or isocyanate groups.

A hot-melt adhesive composition can be a primer for adhesives, such as for moisture-hardening polyurethane adhesives.

Suitable adhesives are commercially available from, for example, the company Sika Schweiz AG, for example under the trade name SikaFlex® or SikaTack®.

Suitable sealing materials are commercially available from, for example, the company Sika Schweiz AG, for example, under the trade name SikaFlex®.

Suitable compositions for the production of coatings are commercially available from, for example, the company Sika Schweiz AG, for example under the trade name SikaFloor®.

In a second aspect, the disclosure is directed to a process for bonding two substrates S1 and S2 comprising:
a1) Application of a molten hot-melt adhesive composition, containing at least one polyurethane polymer that has isocyanate groups and/or silane groups, on a substrate S1 that is to be bonded;
a2) Application of a second adhesive on the hot-melt adhesive composition that is cooled below its melting point and that is found on the substrate S1;
a3) Ensuring contact between the second adhesive and a second substrate S2; or
b1) Application of a molten hot-melt adhesive composition—that contains at least one polyurethane polymer that has isocyanate groups and/or silane groups—on a substrate S1 that is to be bonded;
b2) Application of a second adhesive on the surface of a second substrate S2;
b3) Ensuring contact between the second adhesive and the hot-melt adhesive composition that is cooled below its melting point and that is found on the substrate S1, within the open time of the second adhesive; or
c1) Application of a molten hot-melt adhesive composition—that contains at least one polyurethane polymer that has isocyanate groups and/or silane groups—on a substrate S1 that is to be bonded;
c2) Application of a molten hot-melt adhesive composition—that contains at least one polyurethane polymer that has isocyanate groups and/or silane groups—on a substrate S2 that is to be bonded;
c3) Application of a second adhesive on the hot-melt adhesive composition that is cooled below its melting point and that is found on the substrate S1 and optionally on the hot-melt adhesive composition that is cooled below its melting point and that is found on the substrate S2;
c4) Fusing of the substrate S1—that is coated with a hot-melt adhesive composition and with a second adhesive—with the substrate S2—that is coated with a hot-melt adhesive composition and optionally with a second adhesive—within the open time of the second adhesive; or
d1) Application of a molten hot-melt adhesive composition—that contains at least one polyurethane polymer that has isocyanate groups and/or silane groups—on at least one substrate S1 and/or S2 that is to be bonded;
d2) Cooling of the hot-melt adhesive composition below its melting point;
d3) Application of a second adhesive between the surfaces of the substrates S1 and S2.

The second substrate S2 can comprise (e.g., consist of) the same material as or a different material from substrate S1.

In addition, the disclosure is directed to a process for sealing or coating a substrate S1 and/or S2 that comprises:
e1) Application of a molten hot-melt adhesive composition—that contains at least one polyurethane polymer that has isocyanate groups and/or silane groups—on a substrate S1 and/or S2;
e2) Application of a composition for sealing and/or coating on the hot-melt adhesive composition that is cooled below the melting point and that is found on the substrate S1 and/or S2.

The above-described hot-melt adhesive compositions can be primers for adhesives, sealing materials or for compositions for the production of coatings.

For the operation of the hot-melt adhesive composition as a primer, the hot-melt adhesive composition can be configured fusible (e.g., that it has a low enough viscosity at the application temperature that it can be applied, and that, when cooling, it builds up adequate firmness as quickly as possible (initial firmness)).

The hot-melt adhesive composition can be applied at a temperature in the range of 80° C. to 200° C., such as, 120° C. to 160° C., since it has an easily handled viscosity at these temperatures. In particular, an exemplary viscosity of 1 to 50 Pa·s is defined as easily handled viscosity.

In the process for bonding as well as in the process for sealing or coating (e.g., in one of steps a1), b1), c1), c2), d1) or e1)), the molten hot-melt adhesive composition can be applied for example in a layer thickness of 10 to 300 μm, such as 20 to 250 μm, preferably 50 to 200 μm, on the substrate S1 and/or S2.

The hot-melt adhesive composition can, for example, be applied to the substrate S1 and/or S2 by means of rolling, knife-coating, spraying or by dip-coating.

In the application, the previously-described hot-melt adhesive composition can come into contact with moisture, such as in the form of air humidity. Parallel to the physical curing because of the setting of the hot-melt adhesive composition during cooling, chemical cross-linking with moisture also occurs in a known way.

In the entire document of the process that is triggered by the chemical reaction of isocyanate groups, the development of high-molecular polyurethane plastics is referred to with the terms “cross-linking,” “chemical cross-linking,” and “cross-linking reaction,” although in this case no covalently connected network is created. If the cross-linking reaction in a hot-melt adhesive composition has advanced through the entire mass, it is called “complete curing.”

In another aspect, the disclosure is directed to a layer composite that comprises (e.g., consists of) a substrate S1 and/or a substrate S2, at least one hot-melt adhesive composition that contains at least one polyurethane polymer that has isocyanate groups and/or silane groups, and a composition Z, which is a second adhesive, a sealing material, or a composition for the production of coatings. In this case, one layer of hot-melt adhesive composition adjoins at least one layer of a composition Z. For example, the layer of a hot-melt adhesive composition lies between a substrate S1 or a substrate S2 and a composition Z. In this case, the composition Z is, for example, a moisture-hardening polyurethane composition. For example, the hot-melt adhesive composition and/or the composition Z can be at least partially cured by the effect of water.

For example, the layer composite can be built up so that the substrate S1 or S2 adjoins the hot-melt adhesive composition layer; so that the hot-melt adhesive composition layer in addition adjoins a layer of the composition Z; and so that the layer of the composition Z in addition adjoins a second substrate S2 or S1, whereby optionally a second layer of the hot-melt adhesive composition lies between the layer of the composition Z and the second substrate S2 or S1.

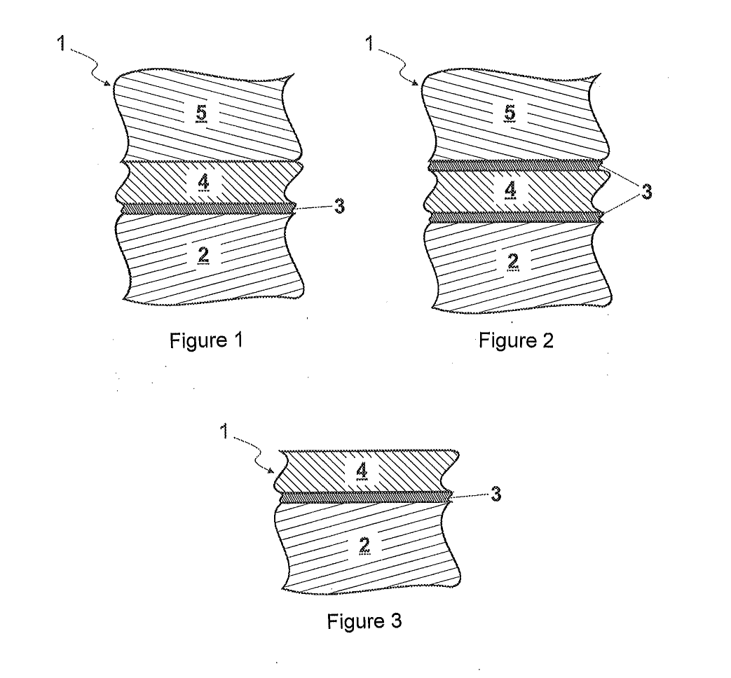

In FIGS. 1 to 3, in each case, layer composites 1, as they are described above, are schematically depicted. The same elements or elements having the same action are provided with the same reference numbers in the various figures. In the figures, only the elements that are essential for direct understanding of the disclosure are shown.

FIG. 1 shows an exemplary embodiment of a layer composite, which is built up from a layer of a substrate S1 2, which is provided with a layer of a hot-melt adhesive composition 3, on which a layer of a composition Z 4 lies, which in turn is covered by a layer of a substrate S2 5. Thus, FIG. 1 schematically shows two substrates S1 and S2, which are bonded to one another via a composition Z. Before the bonding, a layer of a hot-melt adhesive composition was applied as a primer to the substrate S1. In this case, the substrate S2 was bonded without primer.

FIG. 2 shows a second exemplary embodiment of a layer composite, which—with the exception that in addition, a layer of a hot-melt adhesive composition 3 is found between the layer of the composition Z 4 and the substrate S2 5—is the same as the layer composite of FIG. 1. FIG. 2 thus shows schematically two substrates S1 and S2, which were bonded to one another via a composition Z, whereby one layer each of a hot-melt adhesive composition was applied as primer on the two substrates S1 and S2 before the bonding.

FIG. 3 shows a third exemplary embodiment of a layer composite, which is built up from a layer of a substrate S1 2, a layer of a hot-melt adhesive composition 3 lying on top, and a layer of a composition Z 4 lying in turn on top of that. In this embodiment, FIG. 3 schematically shows a substrate S1, which was pretreated with a primer in the form of a hot-melt adhesive composition and then was coated with a composition Z and/or was sealed.

Of course, the disclosure is not limited to the embodiments that are shown and described.

In addition, the disclosure encompasses any article that was bonded, sealed and/or coated according to one of the above-described processes of bonding or sealing or coating.

This article can, for example, be a structure, such as a structure above or below ground level, or an industrial item or a consumer item, such as a window, a household appliance, or a means of transport, such as a vehicle for water or land (e.g., an automobile, a bus, a truck, a train or a boat) and/or a structural attachment of a means of transport.

### EXAMPLES

The following hot-melt adhesive compositions were used:
B1: SikaMelt® 9670, commercially available with the company Sika Automotive GmbH, Germany;
B2: SikaMelt® 9670+5% by weight of polymeric diphenylmethane diisocyanate;
B3: SikaMelt® 9670+5% by weight of polymeric diphenylmethane diisocyanate+2% by weight of Silquest® A 187, which is commercially available from the company Momentive Performance Materials, Inc., USA.
   The compositions B2 and B3 were produced in that B1 was melted, and then the polymeric diphenylmethane diisocyanate or in addition the Silquest® A 187 were added under inert atmosphere and with constant stirring.

For performing the tests, the following substrates were used, which are commercially available from the company Rocholl GmbH, Germany:
Glass test piece: Float glass, downstream face (150×100×3 mm);
Ceramic test piece: VSG ceramic (175×150×4 mm);
Aluminum test piece: Anodized aluminum (297×210×0.8 mm);
Steel test piece: DC-04 steel (297×210×0.8 mm);
PVC test piece: White PVC (297×210×2 mm).
   The substrates were purified with an isopropanol/water mixture (2:1) before the application. Before the purification, the aluminum and steel test pieces were abraded in addition with a Scotch-Brite®, which can be obtained from the company 3M AG, Switzerland.

For performing the tests, the commercially available adhesive SikaTack® Ultrafast that is commercially available from the company Sika Switzerland AG was used.

### Application of the Primer

The hot-melt adhesive compositions were applied to the substrates in a layer thickness of 50 μm using a knife. The application temperature of the primer in this case was 150° C.

### Adhesive Application and Determination of the Adhesion

To examine the adhesion, 5 minutes after the application of the primer, the adhesive (SikaTack® Ultrafast) was applied to the substrates as a round bead with a caulking gun and a nozzle. Then, the adhesive was cured for 7 days at 23° C. and 50% relative air humidity (room temperature—climate-controlled storage: “KL”), and one third of the bead was tested by means of the adhesion test described below. Then, the sample was placed for another 7 days in water at 23° C. (water storage: “WL”). Then, the adhesion was tested by the bead test for another one third of the bead. The painted substrates were then stored for another 7 days at 70° C. and 100% relative air humidity (Cataplasma storage: “CL”), and then the adhesion of the last third of the bead was determined.

During the adhesion test, the cured beads were in each case cut slightly over the surface of the small plate (adhesive surface) on one end. The cut end of the bead was grasped and then carefully and slowly, peeling in the direction of the other end of the bead, pulled from the surface of the small plate. In this case, if the adhesion was so strong that the bead end threatened to tear when pulled, a cut was made perpendicular to the bead-pulling direction up to the smooth surface of the small plate by means of a cutter, and a part was thus detached from the bead. Such cuts were, if necessary, repeated at intervals of 2 to 3 mm as pulling continued. In this way, after each corresponding storage time, one third of the bead was pulled or cut from the small plates. The evaluation of the adhesive properties was carried out based on the cured composition, which remained after the bead on the substrate surface was removed (cohesion rupture), namely by estimating the cohesive portion of the adhesive surface. The evaluation of the adhesive properties is carried out by estimating the cohesive portion of the adhesive surface:

1=>95% Cohesion rupture

2=75-95% Cohesion rupture

3=25-75% Cohesion rupture

4=<25% Cohesion rupture

5=0% Cohesion rupture (pure adhesive rupture)

TABLE 1
Adhesion Results of SikaTack ® Utrafast on
Various Substrates, which are Coated with Different
Primers According to Varying Storage Times.

| Results | | Adhesion | | |
|---|---|---|---|---|
| Substrate | Primer | KL | WL | CL |
| Glass | Ref. (without Primer) | 4 | 4 | 5 |
| | B1 | 2 | 2 | 5 |
| | B2 | 2 | 3 | 2 |
| | B3 | 2 | 2 | 2 |
| Ceramic | Ref. (without Primer) | 5 | 5 | 5 |
| | B1 | 3 | 3 | 5 |
| | B2 | 3 | 5 | 2 |
| | B3 | 2 | 3 | 1 |
| Aluminum | Ref. (without Primer) | 5 | 5 | 3 |
| | B1 | 3 | 5 | 5 |
| | B2 | 3 | 5 | 3 |
| | B3 | 4 | 5 | 2 |
| Steel | Ref. (without Primer) | 3 | 3 | 5 |
| | B1 | 3 | 5 | 4 |
| | B2 | 4 | 5 | 4 |
| | B3 | 2 | 5 | 3 |
| PVC | Ref. (without Primer) | 5 | 5 | 5 |
| | B1 | 3 | 3 | 5 |
| | B2 | 3 | 4 | 4 |
| | B3 | 3 | 4 | 5 |

Thus, it will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

Reference Symbol List

| | |
|---|---|
| 1 | Layer Composite |
| 2 | Substrate S1 |
| 3 | Hot-Melt Adhesive Composition |
| 4 | Composition Z |
| 5 | Substrate S2 |

What is claimed is:

1. A primer formed as a hot-melt adhesive composition comprising:
at least one polyurethane polymer having at least one of isocyanate groups and silane groups; and
at least one of an adhesive, a sealing material and a composition for production of coating.

2. Primer according to claim 1, comprising:
a substrate selected from the group that consists of: concrete, cement, mortar, brick, adobe, gypsum, natural stone, asphalt, metal, metal alloy, wood, ceramic, glass, plastic, powder coating, paint, and varnish.

3. Primer according to claim 1, wherein the at least one adhesive, sealing material, and composition for production of coatings is a moisture-hardening polyurethane composition which cures one-component polyurethane compositions at room temperature by air humidity.

4. Primer according to claim 3, wherein the moisture-hardening polyurethane composition comprises:
at least one polyurethane polymer that has at least one of a silane group and an isocyanate group.

5. Primer according to claim 1, configured as a moisture-hardening polyurethane adhesive.

6. Primer according to claim 1, wherein the hot-melt adhesive composition has less than 5% by weight, relative to a total weight of the hot-melt adhesive composition of organic compounds, which have a boiling point of less than 250° C. at normal pressure or a vapor pressure of greater than 0.1 mbar at 20° C.

7. Process for bonding, comprising:
a1) applying a molten hot-melt adhesive composition containing at least one polyurethane polymer that has at least one of an isocyanate group and a silane group on a substrate that is to be bonded; and
a2) applying a second adhesive on the hot-melt adhesive composition that is cooled below its melting point and that is on the substrate ensuring contact between the second adhesive and a second substrate; or
b1) applying a molten hot-melt adhesive composition that contains at least one polyurethane polymer that has at least one of an isocyanate group and a silane group on a first substrate that is to be bonded; and
b2) applying a second adhesive on a surface of a second substrate ensuring contact between the second adhesive and the hot-melt adhesive composition that is cooled below its melting point and that is on the first substrate, within an open time of the second adhesive; or
c1) applying a molten hot-melt adhesive composition that contains at least one polyurethane polymer that has at least one of an isocyanate group and a silane group on a first substrate that is to be bonded;
c2) applying a molten hot-melt adhesive composition that contains at least one polyurethane polymer that has at least one of an isocyanate group and a silane group on a second substrate that is to be bonded;
c3) applying a second adhesive on the hot-melt adhesive composition that is cooled below its melting point and that is on at least one of the first substrate and the second substrate; and
c4) fusing the first substrate, that is coated with the hot-melt adhesive composition, with the second substrate that is coated with the hot-melt adhesive composition, within an open time of the second adhesive; or
d1) applying a molten hot-melt adhesive composition that contains at least one polyurethane polymer that has at least one of an isocyanate group and a silane group on at least one of a first substrate and a second substrate that is to be bonded;
d2) cooling the hot-melt adhesive composition below its melting point; and
d3) applying a second adhesive between surfaces of the first and second substrates.

8. Process for a substrate, comprising:
applying a molten hot-melt adhesive composition that contains at least one polyurethane polymer that has at least one of an isocyanate group and a silane group on at least one of a first substrate and a second substrate; and
applying a composition on the hot-melt adhesive composition that is cooled below its melting point and that is on at least one of the first substrate and the second substrate.

9. Process according to claim 7, wherein the hot-melt adhesive composition, that contains at least one polyurethane polymer that has isocyanate groups and/or silane groups, is applied in one of the steps a1), b1), c1), c2), d1) or e1) in a layer thickness of 10 to 300 μm on the substrate.

10. Process according to claim 7, wherein the hot-melt adhesive composition, that contains at least one polyurethane polymer and that has at least one of an isocyanate group and a silane group, is applied to at least one of the first substrate and the second substrate by at least one of rolling, knife-coating, spraying and dip-coating.

11. Layer composite, comprising:
a least a first substrate of a hot-melt adhesive composition that contains at least one polyurethane polymer that has at least one of an isocyanate group and a silane groups; and
a second composition, which is a second adhesive, a sealing material, or a composition for the production of coatings, wherein a layer of the hot-melt adhesive composition adjoins at least one layer of the second composition.

12. Layer composite according to claim 11, wherein the layer of hot-melt adhesive composition lies between the first substrate or a second substrate and the second composition, wherein the second composition is a moisture-hardening polyurethane composition.

13. Layer composite according to claim 11, wherein at least one of the hot-melt adhesive composition and the second composition is cured at least partially by an effect of water.

14. Layer composite according to claim 11, wherein at least one of the first substrate and the second substrate adjoins the layer of the hot-melt adhesive composition; wherein the layer of the hot-melt adhesive composition in addition adjoins a layer of the second composition; and wherein the layer of the second composition in addition adjoins at least one of the first substrate and the second substrate.

15. An article produced according to a process for bonding which comprises:
a1) applying a molten hot-melt adhesive composition containing at least one polyurethane polymer that has at least one of an isocyanate group and a silane group on a substrate that is to be bonded; and
a2) applying a second adhesive on the hot-melt adhesive composition that is cooled below its melting point and that is on the substrate ensuring contact between the second adhesive and a second substrate; or
b1) applying a molten hot-melt adhesive composition that contains at least one polyurethane polymer that has at least one of an isocyanate group and a silane group on a first substrate that is to be bonded; and
b2) applying a second adhesive on a surface of a second substrate ensuring contact between the second adhesive and the hot-melt adhesive composition that is cooled below its melting point and that is on the first substrate, within an open time of the second adhesive; or
c1) applying a molten hot-melt adhesive composition that contains at least one polyurethane polymer that has at least one of an isocyanate group and a silane group on a first substrate that is to be bonded;
c2) applying a molten hot-melt adhesive composition that contains at least one polyurethane polymer that has at least one of an isocyanate group and a silane group on a second substrate that is to be bonded;
c3) applying a second adhesive on the hot-melt adhesive composition that is cooled below its melting point and that is on at least one of the first substrate and the second substrate; and
c4) fusing the first substrate, that is coated with the hot-melt adhesive composition, with the second substrate that is coated with the hot-melt adhesive composition, within an open time of the second adhesive; or
d1) applying a molten hot-melt adhesive composition that contains at least one polyurethane polymer that has at least one of an isocyanate group and a silane group on at least one of a first substrate and a second substrate that is to be bonded;
d2) cooling the hot-melt adhesive composition below its melting point; and
d3) applying a second adhesive between surfaces of the first and second substrates.

16. Article according to claim 15, wherein the article is at least one of a structure, an industrial item, a consumer item, a means of transport, and a structural attachment of a means of transport.

17. Primer according to claim 1, wherein the at least one adhesive, sealing material and composition for the production of coatings is a one-component polyurethane composition.

18. Primer according to claim 1, wherein the hot-melt adhesive composition has less than 0% by weight, relative to a total weight of the hot-melt adhesive composition of organic compounds, which have a boiling point of less than 250° C. at normal pressure or a vapor pressure of greater than 0.1 mbar at 20° C.

19. Process according to claim 7, wherein the first and second substrates are each coated with an additional adhesive.

20. Process according to claim 8, wherein the hot-melt adhesive composition, that contains at least one polyurethane polymer that has isocyanate groups and/or silane groups, is applied in one of the steps a1), b1), c1), c2), d1) or e1) in a layer thickness of 10 to 300 μm on the substrate.

21. Layer composite according to claim 14, wherein a second layer of the hot-melt adhesive composition lies between the layer of the second composition and at least one of the first substrate and the second substrate.

22. Process for bonding, comprising:
a1) applying a molten hot-melt adhesive composition containing at least one polyurethane polymer that at least one of an isocyanate group and a silane group on a substrate that is to be bonded; and
a2) applying a second adhesive on the hot-melt adhesive composition that is cooled below its melting point and that is on the substrate ensuring contact between the second adhesive and a second substrate.

23. Process for bonding, comprising:
b1) applying a molten hot-melt adhesive composition that contains at least one polyurethane polymer that has at least one of an isocyanate group and a silane group on a first substrate that is to be bonded; and
b2) applying a second adhesive on a surface of a second substrate ensuring contact between the second adhesive and the hot-melt adhesive composition that is cooled below its melting point and that is on the first substrate, within an open time of the second adhesive.

24. Process for bonding, comprising:
c1) applying a molten hot-melt adhesive composition that contains at least one polyurethane polymer that has at least one of an isocyanate group and a silane group on a first substrate that is to be bonded;
c2) applying a molten hot-melt adhesive composition that contains at least one polyurethane polymer that has at least one of an isocyanate group and a silane group on a second substrate that is to be bonded;
c3) applying a second adhesive on the hot-melt adhesive composition that is cooled below its melting point and that is on at least one of the first substrate and the second substrate; and
c4) fusing the first substrate, that is coated with the hot-melt adhesive composition, with the second substrate that is coated with the hot-melt adhesive composition, within an open time of the second adhesive

25. Process for bonding, comprising:
d1) applying a molten hot-melt adhesive composition that contains at least one polyurethane polymer that has at least one of an isocyanate group and a silane group on at least one of a first substrate and a second substrate that is to be bonded;
d2) cooling the hot-melt adhesive composition below its melting point; and
d3) applying a second adhesive between surfaces of the first and second substrates.

26. Process according to claim 7, wherein the hot-melt adhesive composition, that contains at least one polyurethane polymer that has isocyanate groups and/or silane groups, is applied in one of the steps a1), b1), c1), c2), d1) or e1) in a layer thickness of 50 to 200 μm on the substrate.
